(19) United States
(12) Patent Application Publication
(10) Pub. No.: US 2025/0316899 A1
(43) Pub. Date: Oct. 9, 2025

(54) ANTENNA STRUCTURE

(71) Applicant: POSTECH RESEARCH AND BUSINESS DEVELOPMENT FOUNDATION, Pohang-Si (KR)

(72) Inventors: Won Bin HONG, Seoul (KR); Bum Hyun KIM, Pohang-si (KR)

(73) Assignee: POSTECH RESEARCH AND BUSINESS DEVELOPMENT FOUNDATION, Pohang-Si (KR)

(21) Appl. No.: 18/715,088

(22) PCT Filed: Apr. 4, 2022
(86) PCT No.: PCT/KR2022/004784

§ 371 Date: Oct. 24, 2024

(30) Foreign Application Priority Data
Dec. 2, 2021 (KR) 10-2021-0171275

(51) Int. Cl. H01Q 5/30; H01Q 1/48; H01Q 9/04

(52) U.S. Cl. CPC H01Q 5/30; H01Q 1/48; H01Q 9/045

(57) ABSTRACT

An antenna structure is disclosed. The antenna structure according to one aspect includes: a radiator; a first transmission line and a second transmission line which extend in different directions from each other to be connected to the radiator; a first side ground pad disposed adjacent to the first transmission line; a second side ground pad disposed adjacent to the second transmission line; and a central ground pad disposed between the first transmission line and the second transmission line, wherein the central ground pad includes a slit part, and a length of the central ground pad is longer than the lengths of the first side ground pad and the second side ground pad.

### TECHNICAL FIELD

The present invention relates to an antenna structure.

### BACKGROUND ART

An antenna serves to transmit and receive signals in a wireless device, and is a core element that determines the quality of wireless communication. Recently, according to development of IT technologies, the wireless device is becoming smaller in size and lighter in weight, and in order to meet this trend, the antenna mounted on the wireless device is often being replaced from an external antenna to a built-in antenna.

Therefore, researches on antennas that can radiate signals in the multi-frequency band with reduced size have been continuously performed.

### SUMMARY OF INVENTION

### Problems to be Solved by Invention

An object of the present invention is to provide an antenna structure capable of transmitting and receiving signals in the multi-frequency band.

### Means for Solving Problems

To achieve the above object, according to an aspect of the present invention, there is provided an antenna structure including: a radiator; a first transmission line and a second transmission line which extend in different directions from each other to be connected to the radiator; a first side ground pad disposed adjacent to the first transmission line; a second side ground pad disposed adjacent to the second transmission line; and a central ground pad disposed between the first transmission line and the second transmission line, wherein the central ground pad includes a slit part, and a length of the central ground pad is longer than the lengths of the first side ground pad and the second side ground pad.

The radiator may have a rhombus shape, and the slit part may have a triangular shape.

The first transmission line may include: a first feeding part extending in a longitudinal direction thereof; and a first bent part extending from the first feeding part to be connected to the radiator, and the second transmission line may include: a second feeding part extending in the longitudinal direction; and a second bent part extending from the second feeding part to be connected to the radiator.

The first bent part may be inclined at a first angle clockwise with respect to the longitudinal direction, and the second bent part may be inclined at a second angle counterclockwise with respect to the longitudinal direction.

The central ground pad may include a first cut part and a second cut part, in which both corners thereof on the radiator side are cut.

The first cut part may be substantially parallel to the first bent part, and the second cut part may be substantially parallel to the second bent part.

The slit part may have a shape substantially the same as the shape of a portion of the radiator adjacent to the slit part.

The slit part may be substantially parallel to a facing side of the radiator portion.

Power feed signals having the same phase may be applied to the first transmission line and the second transmission line.

### Advantageous effects

The antenna structure according to an exemplary embodiment may include a plurality of transmission lines connected to the radiator in different directions from each other, two side ground pads, and a central ground pad which includes a slit part and has a longer length than those of the side ground pads. This structure may substantially provide different polarization directions and different frequency band coverages.

According to an exemplary embodiment, by applying power feed signals having the same phase to the plurality of transmission lines, a wideband dual-band antenna may be implemented.

### BRIEF DESCRIPTION OF THE DRAWINGS

FIG. 1 is a schematic cross-sectional view illustrating an antenna structure according to an exemplary embodiment.

FIG. 2 is a schematic plan view illustrating an antenna structure according to an exemplary embodiment.

FIGS. 3 and 4 are schematic plan views illustrating antenna structures according to exemplary embodiments.

FIG. 5 is a schematic plan view illustrating an antenna structure according to an exemplary embodiment.

FIGS. 6 and 7 are diagrams illustrating results of S11 and peak realized gain measured in the antenna structures according to examples.

FIG. 8 is diagrams illustrating measured results of S11 and peak realized gain according to a length a of a central ground pad.

FIG. 9 is diagrams illustrating measured results of S11 and peak realized gain according to a length b of side ground pads.

### MODE FOR CARRYING OUT INVENTION

Hereinafter, preferred embodiments of the present invention will be described in detail with reference to the accompanying drawings. However, since the drawings attached to the present disclosure are only given for illustrating one of several preferred embodiments of present invention to easily understand the technical spirit of the present invention with the above-described invention, it should not be construed as limited to such a description illustrated in the drawings.

An antenna structure described in the present disclosure may be a microstrip patch antenna. For example, the antenna structure may be applied to electronic devices for high frequency or ultra high frequency such as 3G, 4G, 5G or higher mobile communication, for example. Herein, the electronic device may include a mobile phone, a smartphone, a tablet, a laptop computer, a personal digital assistant (PDA), a portable multimedia player (PMP), a navigation device, an MP3 player, a digital camera, a wearable device and the like. The wearable device may include a wristwatch type, a wrist band type, a ring type, a belt type, a necklace type, an ankle band type, a thigh band type, a forearm band type wearable device or the like. However, the electronic device is not limited to the above-described example, and the wearable device is also not limited to the above-described example. In addition, the antenna structure may be applied to various objects or structures such as vehicles and buildings.

In the following drawings, two directions which are parallel to an upper surface of a dielectric layer and cross each other perpendicularly are defined as an x-direction and a y-direction, and a direction perpendicular to the upper surface of the dielectric layer is defined as a z-direction. For example, the x-direction may correspond to a width direction of the antenna structure, the y-direction may correspond to a length direction of the antenna structure, and the z-direction may correspond to a thickness direction of the antenna structure.

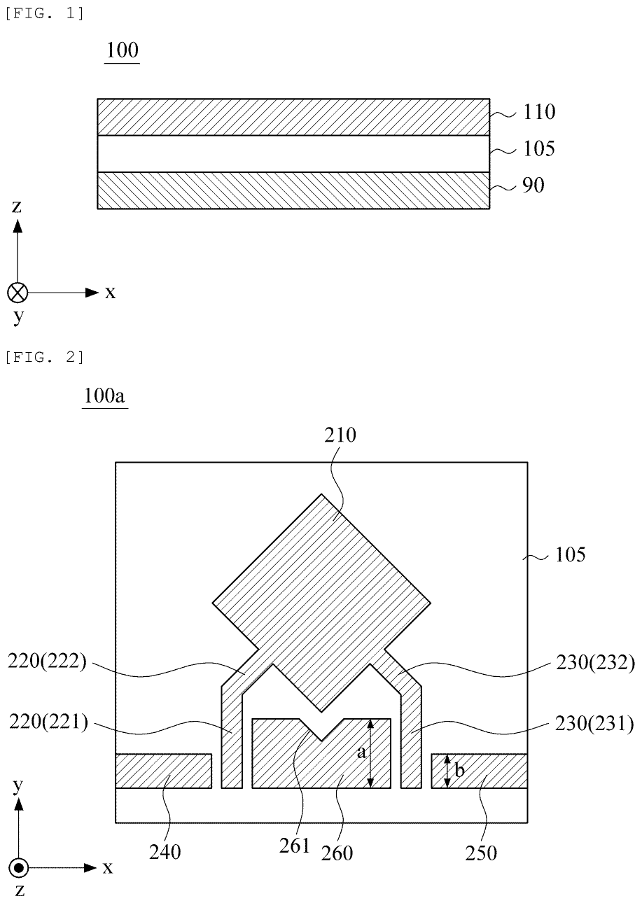

FIG. 1 is a schematic cross-sectional view illustrating an antenna structure according to an exemplary embodiment.

Referring to FIG. 1, an antenna structure 100 according to an exemplary embodiment may include a dielectric layer 105 and an antenna pattern layer 110.

The dielectric layer 105 may include an insulation material having a predetermined dielectric constant. According to an embodiment, the dielectric layer 105 may include an inorganic insulation material such as glass, silicon oxide, silicon nitride, or metal oxide, or an organic insulation material such as an epoxy resin, an acrylic resin, or imide resin. The dielectric layer 105 may function as a film substrate of the antenna structure 100 on which the antenna pattern layer 110 is formed.

According to an exemplary embodiment, the dielectric layer 105 may include a transparent resin material. For example, the dielectric layer 105 may include a polyester resin such as polyethylene terephthalate, polyethylene isophthalate, polyethylene naphthalate, polybutylene terephthalate, etc.; a cellulose resin such as diacetyl cellulose, triacetyl cellulose, etc.; a polycarbonate resin; an acrylic resin such as polymethyl(meth)acrylate, polyethyl (meth)acrylate, etc.; a styrene resin such as polystyrene, acrylonitrile-styrene copolymer, etc.; a polyolefin resin such as polyethylene, polypropylene, cyclic polyolefin or polyolefin having a norbornene structure, ethylene-propylene copolymer, etc.; a vinyl chloride resin; an amide resin such as nylon, aromatic polyamide; an imide resin; a polyether sulfonic resin; a sulfonic resin; a polyether ether ketone resin; a polyphenylene sulfide resin; a vinylalcohol resin; a vinylidene chloride resin; a vinylbutyral resin; an allylate resin; a polyoxymethylene resin; an epoxy resin; a urethane or acrylic urethane resin, a silicone resin and the like. These may be used alone or in combination of two or more thereof.

According to an embodiment, an adhesive film such as an optically clear adhesive (OCA), an optically clear resin (OCR), and the like may also be included in the dielectric layer 105.

According to an embodiment, the dielectric layer 105 may be formed in a substantial single layer, or may be formed in a multilayer structure of two or more layers.

Capacitance or inductance may be generated by the dielectric layer 105, thus to adjust a frequency band which can be driven or sensed by the antenna structure 100. When the dielectric constant of the dielectric layer 105 exceeds about 12, a driving frequency is excessively reduced, such that driving of the antenna in a desired high frequency band may not be implemented. Therefore, according to an embodiment, the dielectric constant of the dielectric layer 105 may be adjusted in a range of about 1.5 to 12, and preferably about 2 to 12.

According to an exemplary embodiment, when the antenna structure 100 is mounted on an image display device, an insulation layer (e.g., an encapsulation layer, a passivation layer, etc. of a display panel) inside the image display device may be provided as the dielectric layer 105.

The antenna pattern layer 110 may be disposed on an upper surface of the dielectric layer 105.

The antenna pattern layer 110 may include low resistance metal such as silver (Ag), gold (Au), copper (Cu), aluminum (Al), platinum (Pt), palladium (Pd), chromium (Cr), titanium (Ti), tungsten (W), niobium (Nb), tantalum (Ta), vanadium (V), iron (Fe), manganese (Mn), cobalt (Co), nickel (Ni), zinc (Zn), tin (Sn), molybdenum (Mo), calcium (Ca), or an alloy including at least one thereof. These may be used alone or in combination of two or more thereof. For example, the antenna pattern layer 110 may include silver (Ag) or a silver alloy (e.g., a silver-palladium-copper (APC) alloy) to implement a low resistance. For another example, the antenna pattern layer 110 may include copper (Cu) or a copper alloy (e.g., a copper-calcium (CuCa) alloy) in consideration of low resistance and fine line width patterning.

According to an exemplary embodiment, the antenna pattern layer 110 may include a transparent conductive oxide such as indium tin oxide (ITO), indium zinc oxide (IZO), indium zinc tin oxide (IZTO), zinc oxide (ZnOx), or copper oxide (CuO).

According to an exemplary embodiment, the antenna pattern layer 110 may include a lamination structure of a transparent conductive oxide layer and metal layer, and for example, may have a two-layer structure of transparent conductive oxide layer-metal layer or a three-layer structure of transparent conductive oxide layer-metal layer-transparent conductive oxide layer. In this case, resistance may be reduced to improve signal transmission speed while improving flexible properties by the metal layer, and corrosion resistance and transparency may be improved by the transparent conductive oxide layer.

According to an exemplary embodiment, the antenna structure 100 may further include a ground layer 90. Since the antenna structure 100 includes the ground layer 90, vertical radiation characteristics may be implemented.

The ground layer 90 may be disposed on a lower surface of the dielectric layer 105. The ground layer 90 may be overlapped with the antenna pattern layer 110 with the dielectric layer 105 interposed therebetween. For example, the ground layer 90 may be overlapped with a radiator of the antenna pattern layer 110.

According to an exemplary embodiment, when the antenna structure 100 is mounted on the image display device, a conductive member of the image display device or the display panel may be provided as the ground layer 90. For example, the conductive member includes electrodes or wirings (such as a gate electrode, source/drain electrodes, pixel electrode, common electrode, data line, scan line, etc.) included in a thin film transistor (TFT) array panel, a stainless steel (SUS) plate, a sensor member such as a digitizer, a heat dissipation sheet and the like.

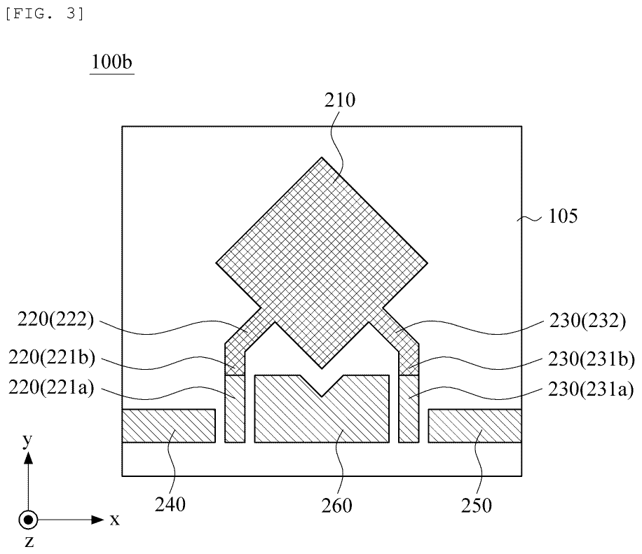

FIG. 2 is a schematic plan view illustrating an antenna structure according to an exemplary embodiment. An antenna structure 100a shown in FIG. 2 may be an embodiment of the antenna structure 100 shown in FIG. 1.

Referring to FIGS. 1 and 2, the antenna structure 100a according to an exemplary embodiment includes an antenna pattern layer 110 disposed on a dielectric layer 105, and the antenna pattern layer 110 may include a radiator 210, a first transmission line 220, a second transmission line 230, a first side ground pad 240, a second side ground pad 250 and a central ground pad 260.

The radiator 210 may be electrically connected to the first transmission line 220 and the second transmission line 230, thus to be supplied with power through the first transmission line 220 and/or the second transmission line 230. Specifically, the radiator 210 may receive a power feed signal from the first transmission line 220 and/or the second transmission line 230, convert it into an electromagnetic wave signal, and radiate the converted electromagnetic wave signal.

According to an exemplary embodiment, as shown in FIG. 2, the radiator 210 may be implemented in a rhombus shape. However, this is only an example and it is not limited thereto. That is, the radiator 210 may be implemented in various shapes such as a circle, rectangle or the like.

A size of the radiator 210 may be determined depending on a desired resonance frequency, radiation resistance and gain.

The first transmission line 220 and the second transmission line 230 may be electrically connected to the radiator 210 to apply the power feed signal to the radiator 210. For example, when the radiator 210 is implemented in a rhombus shape as shown in FIG. 2, the first transmission line 220 and the second transmission line 230 may be connected to two neighboring sides of the radiator 210, respectively. In this case, the first transmission line 220 and the second transmission line 230 may be connected to a center of each side.

According to an exemplary embodiment, the transmission lines 220 and 230 may include substantially the same conductive material as the radiator 210. In addition, the transmission lines 220 and 230 may be integrally connected with the radiator 230 to be formed as a substantial single member, or may be formed as a separate member from the radiator 210.

The first transmission line 220 and the second transmission line 230 may be arranged symmetrically to each other. For example, the first transmission line 220 and the second transmission line 230 may be disposed symmetrically about a center line in the y direction.

The transmission lines 220 and 230 may include a feeding part and a bent part, respectively. For example, the first transmission line 220 may include a first feeding part 221 and a first bent part 222, and the second transmission line 230 may include a second feeding part 231 and a second bent part 232.

According to an exemplary embodiment, the first feeding part 221 and the second feeding part 231 may extend in the y direction. The first feeding part 221 and the second feeding part 231 may be substantially parallel to each other.

The first bent part 222 may be bent from the first feeding part 221 toward the radiator 210 and may be directly connected to or in contact with the radiator 210. The second bent part 232 may be bent from the second feeding part 231 toward the radiator 210 and may be directly connected to or in contact with the radiator 210. The first bent part 222 and the second bent part 232 may extend in different directions from each other and be connected to the radiator 210. According to an exemplary embodiment, an angle between directions in which the first bent part 222 and the second bent part 232 extend may be substantially about 90°. For example, the first bent part 222 may be inclined at 45° clockwise with respect to the y direction, and the second bent part 232 may be inclined at 45° counterclockwise with respect to the y direction.

Preferably, the first bent part 222 and the second bent part 232 may extend toward the center of the radiator 210, respectively.

Depending on the structure and arrangement of the above-described bent parts 222 and 232, power may be fed to the radiator 210 through the first transmission line 220 and the second transmission line 230 in two substantially orthogonal directions. Accordingly, dual polarization characteristics may be implemented from one radiator 210.

The first side ground pad 240 may be disposed adjacent to the first transmission line 220, the second side ground pad 250 may be disposed adjacent to the second transmission line 230, and the central ground pad 260 may be disposed between the first transmission line 220 and the second transmission line 230. For example, the first side ground pad 240 may face the central ground pad 260 with the first transmission line 220 interposed therebetween. In addition, the second side ground pad 250 may face the central ground pad 260 with the second transmission line 230 interposed therebetween.

A length in the y-direction of the first side ground pad 240 and a length in the y-direction of the second side ground pad 240 may be substantially the same. The central ground pad 260 may include a slit part 261.

According to an exemplary embodiment, as shown in FIG. 2, the slit part 261 may have a triangular shape. However, this is only an example and it is not limited thereto. That is, the slit part 261 may have various shapes such as a semi-circle, semi-ellipse, T shape, rectangle or the like.

A length a in the y-direction of the central ground pad 260 may be longer than a length b in the y-direction of the first side ground pad 240 and/or the second side ground pad 250.

According to an exemplary embodiment, all the radiator 210, the transmission lines 220 and 230, and the ground pads 240, 250 and 260 may be disposed in the same level or layer as each other on the upper surface of the dielectric layer 105. For example, all the radiator 210, the transmission lines 220 and 230, and the ground pads 240, 250 and 260 may be formed by patterning from the same conductive layer.

The antenna structure 100a according to an exemplary embodiment may connect the first transmission line 220 and the second transmission line 230 to the radiator 210 in directions intersecting each other. Through this dual transmission line structure, dual polarization characteristics may be implemented.

According to an embodiment, power feed signals having the same phase may be applied to the first transmission line 220 and the second transmission line 230.

Due to a combination of applying power feed signals having the same phase, the dual transmission line structure and the shapes of the ground pads 240, 250 and 260, the antenna structure 100a may be provided as a wideband antenna operating in a dual resonance frequency band.

According to an embodiment, the antenna structure 100a may be provided as a dual band antenna. For example, a first resonance frequency peak in a range of 27 to 30 GHZ and a second resonance frequency peak in a range of 36 to 40 GHZ may be provided from the antenna structure 100a.

Meanwhile, FIG. 2 shows an example in which the central ground pad 260 includes one slit part 261, but this is only an example and it is not limited thereto. That is, the central ground pad 260 may include two or more slit parts 261 depending on the desired resonance frequency, gain, bandwidth and the like.

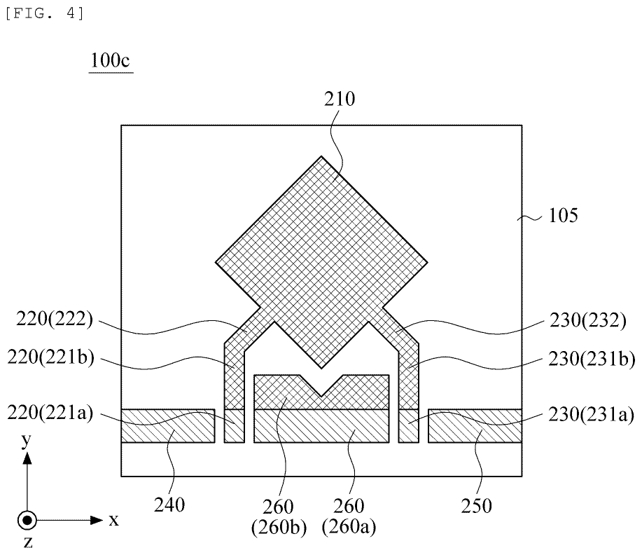

FIGS. 3 and 4 are schematic plan views illustrating antenna structures according to exemplary embodiments. Antenna structures 100b and 100c shown in FIGS. 3 and 4 may be an embodiment of the antenna structure 100 shown in FIG. 1. Configurations and structures that are substantially the same or similar to those described with reference to FIGS. 1 and 2 will not be described in detail.

Referring to FIG. 3, an antenna pattern layer 110 may include a mesh structure. According to an exemplary embodiment, a radiator 210 may entirely include a mesh structure, and a first transmission line 220 and a second transmission line 230 may partially include a mesh structure.

For example, a first side ground pad 240, a second side ground pad 250, and a central ground pad 260 may include a solid structure, and a first feeding part 221 of the first transmission line 220 and a second feeding part 231 of the second transmission line 230 may partially include a mesh structure.

According to an embodiment, the first feeding part 221 may include a first solid part 221a and a first mesh part 221b. The second feeding part 231 may include a second solid part 231a and a second mesh part 231b.

The first solid part 221a may be disposed between the first side ground pad 240 and the central ground pad 260, which have a solid structure. The second solid part 231a may be disposed between the central ground pad 260 and the second side ground pad 250, which have a solid structure.

According to an exemplary embodiment, portions of the antenna pattern layer 110 having the mesh structure, such as the radiator 210, the first bent part 222 and the first mesh part 221b of the first transmission line 220, the second bent part 232 and the second mesh part 231b of the second transmission line 230 may be disposed in a display region of the image display device. Accordingly, the transmittance through the antenna pattern layer 110 may be improved to prevent image quality of the image display device from being deteriorated.

According to an exemplary embodiment, a dummy mesh pattern (not shown) may be formed around the portions of the antenna pattern layer 110 disposed in the display region. In this case, by uniformly arranging the pattern structure, it is possible to prevent the antenna pattern layer 110 from being viewed by a user.

According to an exemplary embodiment, the portions of the antenna pattern layer 110 having the solid structure, such as the first side ground pad 240, the second side ground pad 250, the central ground pad 260, and the first solid part 221a of the first transmission line 220, and the second solid part 231a of the second transmission line 230 may be disposed in a light-shielding region or bezel region of the image display device. Accordingly, power feed efficiency may be improved by using a low resistance solid metal film.

Referring to FIG. 4, the central ground pad 260 may also partially include a mesh structure.

The central ground pad 260 may include a solid ground part 260a and a mesh ground part 260b.

The lengths of the mesh parts may also be extended in the first feeding part 221 of the first transmission line 220 and the second feeding part 231 of the second transmission line 230. For example, compared to the embodiment shown in FIG. 3, the lengths in the y-direction of the first mesh part 221b and the second mesh part 231b may be extended by the length in the y-direction of the mesh ground part 260b.

For example, when the bezel region is reduced as the display region of the image display device expands, optical characteristics may be improved by also partially adopting the mesh structure in the central ground pad 260.

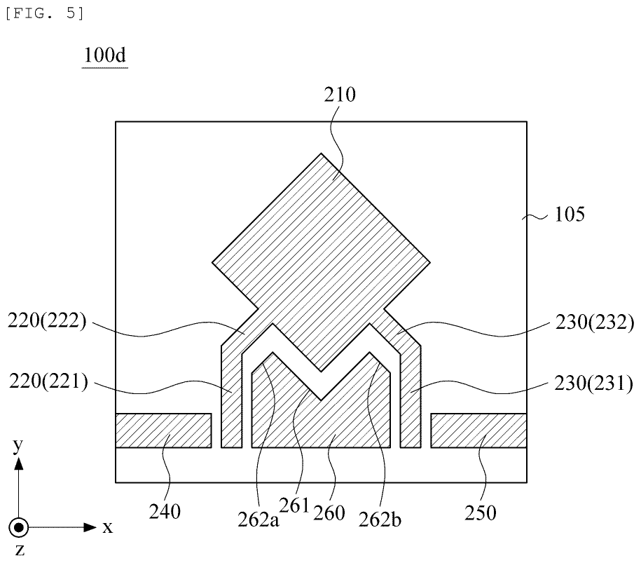

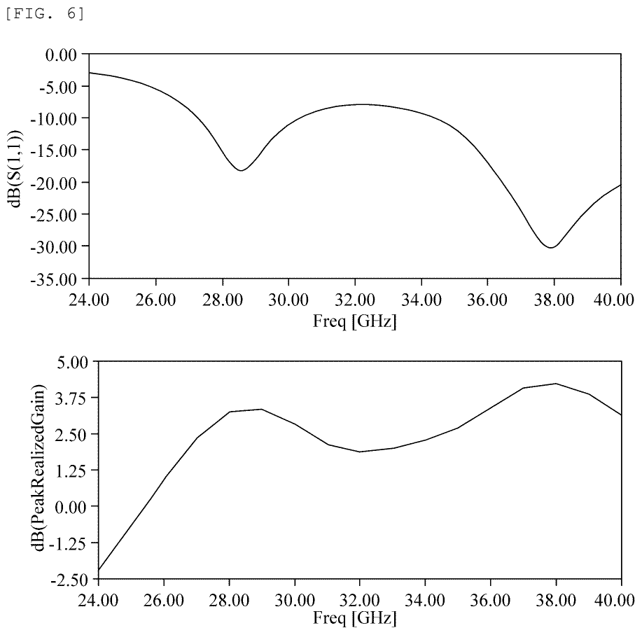

FIG. 5 is a schematic plan view illustrating an antenna structure according to an exemplary embodiment. An antenna structure 100d shown in FIG. 5 may be an embodiment of the antenna structure 100 shown in FIG. 1. Configurations and structures that are substantially the same or similar to those described with reference to FIGS. 1 to 4 will not be described in detail.

Referring to FIG. 5, a central ground pad 260 may further include a first cut part 262a and a second cut part 262b. For example, both corners on a side in the y-direction of the central ground pad 260, for example, on the radiator 210 side, have a diagonally cut shape, and may extend along the bent parts 222 and 232 to form the first cut part 262a and the second cut part 262b. The first cut part 262a may be spaced apart from the first bent part 222 at a predetermined interval to be substantially parallel to a facing side of the first bent part 222. In addition, the second cut part 262b may be spaced apart from the second bent part 232 at a predetermined interval to be substantially parallel to a facing side of the second bent part 232.

The slit part 261 of the central ground pad 260 may have substantially the same shape as the shape of a portion of the radiator 210 adjacent to the slit part 261. For example, as shown in FIG. 5, when the radiator 210 is implemented in a rhombus shape, the slit part 261 may have a triangular shape which is substantially the same as the shape of the portion of the radiator 210 adjacent to the central ground pad 260. The slit part 261 may be spaced apart from the radiator 210 predetermined interval to be substantially parallel to a facing side of the radiator 210.

Meanwhile, according to an exemplary embodiment, a plurality of the above-described antenna structures 100a, 100b, 100c and 100d may be arranged in a predetermined direction to form an array antenna. In this case, a separation distance between the neighboring antenna structures may be appropriately selected within a range that can reduce an occurrence of unwanted coupling between the neighboring antenna structures.

### Experimental Example 1

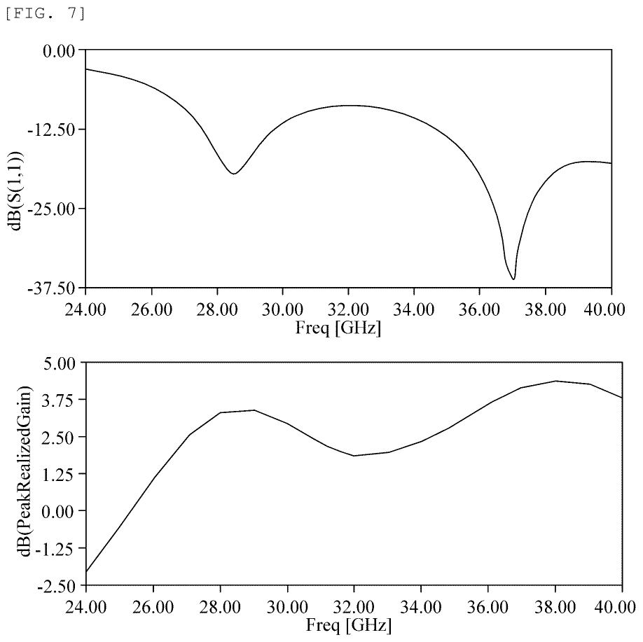

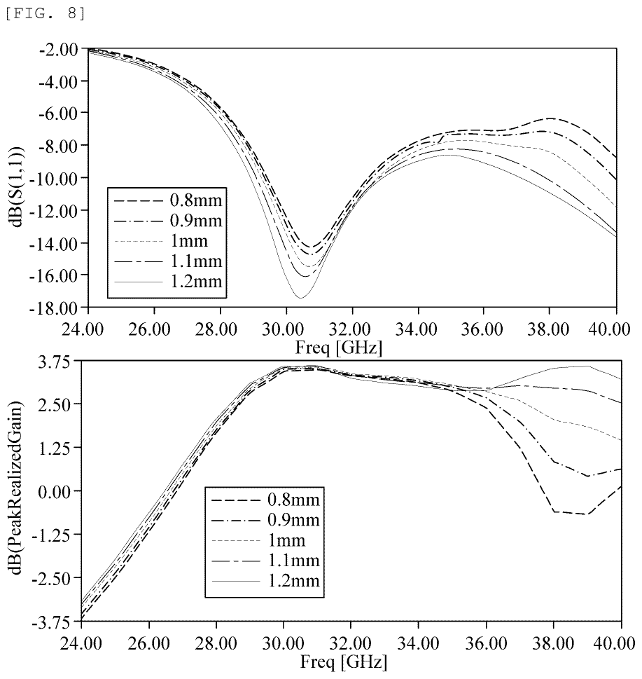

The antenna structure shown in FIG. 2 (Example 1) and the antenna structure shown in FIG. 5 (Example 2) were prepared. S11 and peak realized gain were measured by applying signals having the same phase to the first transmission line and second transmission line of each antenna structure (Example 1 and Example 2), and consequently, results shown in FIG. 6 (Example 1) and FIG. 7 (Example 2) could be obtained.

Referring to FIGS. 6 and 7, it could be confirmed that both the antenna structures of Example 1 and Example 2 might implement a wideband dual-band antenna by applying power feed signals having the same phase to the first transmission line and the second transmission line.

### Experimental Example 2

Five antenna structures shown in FIG. 2 were

manufactured. In this case, the antenna structures were manufactured by fixing the length b in the y-direction of the first side ground pad and the second side ground pad at 0.6 mm, and setting the length a in the y-direction of the central ground pad to 0.8, 0.9, 1.0, 1.1 and 1.2 mm, respectively.

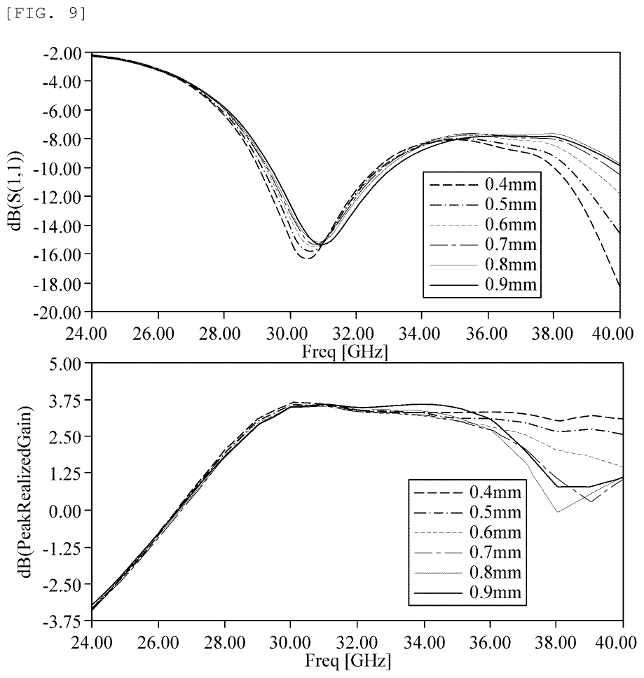

S11 and peak realized gain were measured by applying signals to each antenna structure, and consequently, results shown in FIG. 8 could be obtained.

Referring to FIG. 8, it could be confirmed that the gain was increased in a frequency band ranging from 36 to 40 GHz as the length a in the y-direction of the central ground pad was increased.

### Experimental Example 3

Six antenna structures shown in FIG. 2 were manufactured. In this case, the antenna structures were manufactured by fixing the length a in the y-direction of the central ground pad at 1.0 mm, and setting the length b in the y-direction of the first side ground pad and the second side ground pad to 0.4, 0.5, 0.6, 0.7, 0.8 and 0.9 mm, respectively.

S11 and peak realized gain were measured by applying signals to each antenna structure, and consequently, results shown in FIG. 9 could be obtained.

Referring to FIG. 9, it could be confirmed that the gain was increased in a frequency band ranging from 36 to 40 GH as the length b in the y-direction of the first side ground pad and the second side ground pad was decreased.

The present invention has been described with reference to the preferred embodiments above, and it will be understood by those skilled in the art that various modifications may be made within the scope without departing from essential characteristics of the present invention. Accordingly, it should be interpreted that the scope of the present invention is not limited to the above-described embodiments, and other various embodiments within the scope equivalent to those described in the claims are included within the present invention.

1. An antenna structure comprising:
a radiator;
a first transmission line and a second transmission line which extend in different directions from each other to be connected to the radiator;
a first side ground pad disposed adjacent to the first transmission line;
a second side ground pad disposed adjacent to the second transmission line; and
a central ground pad disposed between the first transmission line and the second transmission line,
wherein the central ground pad includes a slit part, and a length of the central ground pad is longer than the lengths of the first side ground pad and the second side ground pad.

2. The antenna structure according to claim 1,
wherein the radiator has a rhombus shape, and the slit part has a triangular shape.

3. The antenna structure according to claim 1,
wherein the first transmission line comprises:
a first feeding part extending in a longitudinal direction thereof; and
a first bent part extending from the first feeding part to be connected to the radiator, and
wherein the second transmission line comprises:
a second feeding part extending in the longitudinal direction; and
a second bent part extending from the second feeding part to be connected to the radiator.

4. The antenna structure according to claim 3,
wherein the first bent part is inclined at a first angle clockwise with respect to the longitudinal direction, and the second bent part is inclined at a second angle counterclockwise with respect to the longitudinal direction.

5. The antenna structure according to claim 3,
wherein the central ground pad includes a first cut part and a second cut part, in which both corners thereof on the radiator side are cut.

6. The antenna structure according to claim 5,
wherein the first cut part is substantially parallel to the first bent part, and the second cut part is substantially parallel to the second bent part.

7. The antenna structure according to claim 1,
wherein the slit part has a shape substantially the same as the shape of a portion of the radiator adjacent to the slit part.

8. The antenna structure according to claim 7,
wherein the slit part is substantially parallel to a facing side of the radiator portion.

9. The antenna structure according to claim 1,
wherein power feed signals having the same phase are applied to the first transmission line and the second transmission line.
